(19) United States
(12) Patent Application Publication
(10) Pub. No.: US 2025/0063595 A1
(43) Pub. Date: Feb. 20, 2025

(54) APPARATUS, SYSTEM, AND METHOD OF MULTI-LINK WIRELESS COMMUNICATION

(71) Applicant: Intel Corporation, Santa Clara, CA (US)

(72) Inventors: Oded Liron, Haifa (IL); Danny Alexander, Monoson (IL); Danny Ben-Ari, Hasharon Hatichon (IL); Nadav Szanto, Haifa (IL); Ehud Reshef, Kiryat Tivon (IL)

(73) Assignee: Intel Corporation, Santa Clara, CA (US)

(21) Appl. No.: 18/399,318

(22) Filed: Dec. 28, 2023

Related U.S. Application Data
(60) Provisional application No. 63/520,192, filed on Aug. 17, 2023.

(51) Int. Cl. H04W 74/0816; H04B 17/336; H04W 74/08; H04W 76/20

(52) U.S. Cl. CPC H04W 74/0816; H04B 17/336; H04W 74/0875; H04W 76/20

(57) ABSTRACT

For example, a non Access Point (AP) (non-AP) Multi-Link Device (MLD) may be configured to assign a first priority to a first link of a multi-link operation mode and a second priority to a second link of the multi-link operation mode. For example, the first priority assigned to the first link of the multi-link operation mode may be higher than the second priority assigned to the second link of the multi-link operation mode. For example, the non-AP MLD may be configured to limit a transmission from the non-AP MLD over the second link based, for example, on a busy state of a wireless communication medium of the first link.

### CROSS REFERENCE

This application claims the benefit of and priority from U.S. Provisional Patent Application No. 63/520,192 entitled “APPARATUS, SYSTEM, AND METHOD OF MULTI-LINK WIRELESS COMMUNICATION”, filed Aug. 17, 2023, the entire disclosure of which is incorporated herein by reference.

### BACKGROUND

Devices in a wireless communication system may be configured to communicate over one or more communication links.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a multi-link communication scenario to illustrate technical issues, when may be addressed in accordance with some demonstrative aspects.

FIG. 5 is a schematic illustration of multi-link communication, in accordance with some demonstrative aspects.

FIG. 6 is a schematic illustration of multi-link communication, in accordance with some demonstrative aspects.

FIG. 7 is a schematic flow-chart illustration of a method of multi-link wireless communication, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology-Telecommunications and Information Exchange between Systems Local and Metropolitan Area Networks-Specific Requirements; Part 11: Wireless LAN Medium Access Control (MAC) and Physical Layer (PHY) Specifications, December 2020); and/or IEEE 802.11be (IEEE P802.11be/D4.0 Draft Standard for Information technology-Telecommunications and information exchange between systems Local and metropolitan area networks-Specific requirements; Part 11: Wireless LAN Medium Access Control (MAC) and Physical Layer (PHY) Specifications; Amendment 8: Enhancements for extremely high throughput (EHT), July 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHZ.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHZ channels. For example, the channel bonding mechanisms may include, for example, a mechanism and/or an operation whereby two or more channels, e.g., 2.16 GHZ channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHZ, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

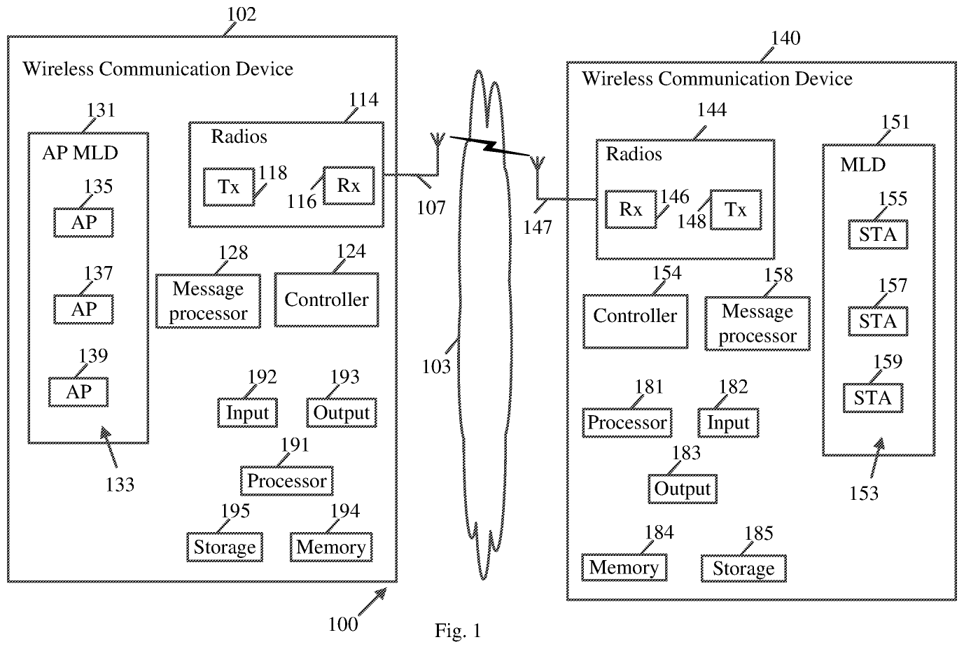

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternative include one or more channels in an mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102 and/or device 140 may be configured to perform one or more operations, and/or functionalities of a WiFi 8 STA.

In other aspects, for example, devices 102 and/or 140 may be configured to perform one or more operations, and/or functionalities of an Ultra High Reliability (UHR) STA.

In other aspects, for example, devices 102 and/or 140 may be configured to perform one or more operations, and/or functionalities of any other additional or alternative type of STA.

In other aspects, device 102 and/or device 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured operate as, perform the role of, and/or perform one or more functionalities of, an access point (AP), e.g., an EHT AP STA and/or a UHR AP STA.

In some demonstrative aspects, device 102 and/or device 140 may be configured to operate as, perform the role of, and/or perform one or more functionalities of, a non-AP STA, e.g., an EHT non-AP STA and/or a UHR non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, a UHR network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side. In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to cause, trigger, instruct and/or control device 102 to operate as, perform a role of, and/or perform one or more operations and/or functionalities of, an AP MLD 131 including a plurality of AP STAs 133, e.g., including an AP STA 135, an AP STA 137 and/or an AP STA 139. In some aspects, as shown in FIG. 1, AP MLD 131 may include three AP STAs. In other aspects, AP MLD 131 may include any other number of AP STAs.

In one example, AP STA 135, AP STA 137 and/or AP STA 139 may operate as, perform a role of, and/or perform one or more operations and/or functionalities of, an EHT AP STA. In other aspects, AP STA 135, AP STA 137 and/or AP STA 139 may perform any other additional or alternative functionality.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, the radios 114 utilized by APs 133 may be implemented as separate radios. In other aspects, the radios 114 utilized by APs 133 may be implemented by one or more shared and/or common radios and/or radio components.

In other aspects, controller 124 may be configured to cause, trigger, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to cause, trigger, instruct and/or control device 140 to operate as, perform a role of, and/or perform one or more operations and/or functionalities of, an MLD 151 including a plurality of STAs 153, e.g., including a STA 155, a STA 157 and/or a STA 159. In some aspects, as shown in FIG. 1, MLD 151 may include three STAs. In other aspects, MLD 151 may include any other number of STAs.

In one example, STA 155, STA 157 and/or STA 159 may operate as, perform a role of, and/or perform one or more operations and/or functionalities of, an EHT STA. In other aspects, STA 155, STA 157 and/or STA 159 may perform any other additional or alternative functionality.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to cause, trigger, instruct and/or control MLD 151 to operate as, perform a role of, and/or perform one or more operations and/or functionalities of, a non-AP MLD. For example, STA 155, STA 157 and/or STA 159 may operate as, perform a role of, and/or perform one or more operations and/or functionalities of, a non-AP EHT STA.

In some demonstrative aspects, controller 154 may be configured to cause, trigger, instruct and/or control MLD 151 to operate as, perform a role of, and/or perform one or more operations and/or functionalities of, an AP MLD. For example, STA 155, STA 157 and/or STA 159 may operate as, perform a role of, and/or perform one or more operations and/or functionalities of, an AP EHT STA.

In other aspects controller 154 may be configured to cause, trigger, instruct and/or control device 140 to operate as, perform a role of, and/or perform one or more operations and/or functionalities of, any other additional or alternative entity and/or STA, e.g., a single STA, multiple STAs, and/or a non-MLD entity.

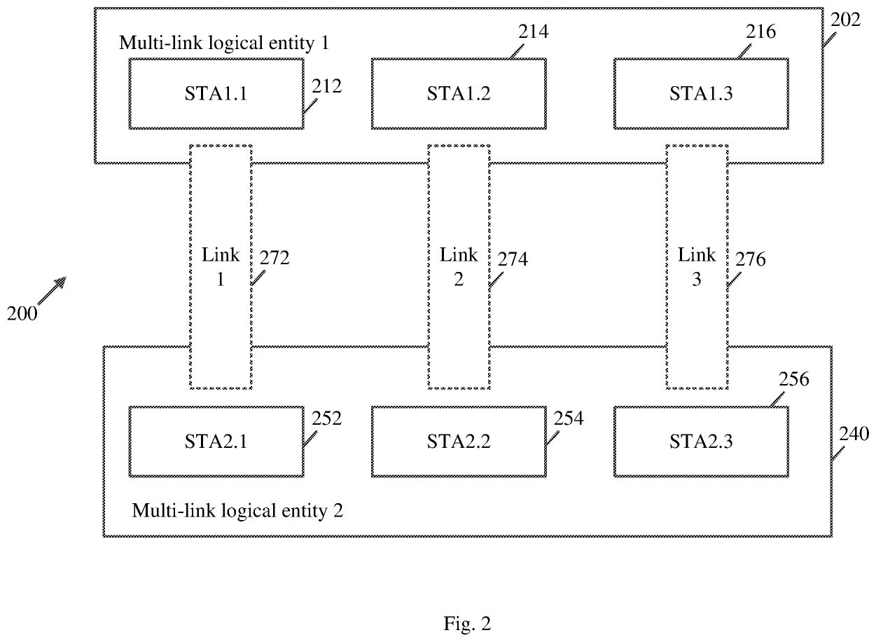

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, and a STA 216. In one example, AP MLD 131 (FIG. 1) may perform one or more operations, one or more functionalities, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, and a STA 256. In one example, MLD 151 (FIG. 1) may perform one or more operations, one or more functionalities, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, and/or a link 276 between STA 216 and STA 256.

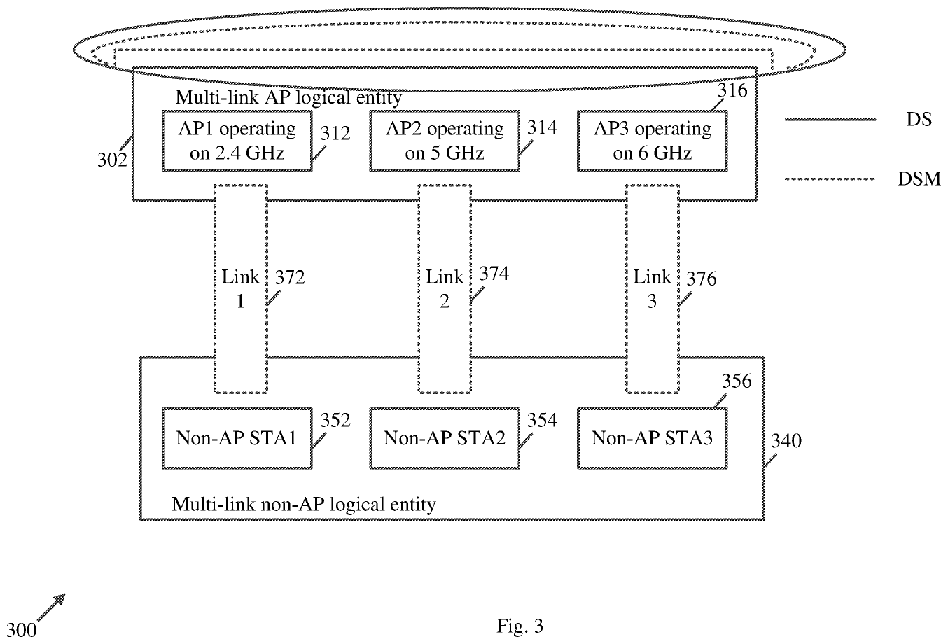

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, and an AP STA 316. In one example, AP MLD 131 (FIG. 1) may perform one or more operations, one or more functionalities, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, and a non-AP STA 356. In one example, MLD 151 (FIG. 1) may perform one or more operations, one or more functionalities, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, and/or a link 376 between AP STA 316 and non-AP STA 356.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, and/or AP STA 316 may be configured to communicate over a 6 GHz frequency band. In other aspects, AP STA 312, AP STA 314, and/or AP STA 316, may be configured to communicate over any other additional or alternative wireless communication frequency bands.

Referring back to FIG. 1, in some demonstrative aspects, device 102 and/or device 140 may be configured to communicate according to a multi-link communication mechanism, e.g., as described below.

In some demonstrative aspects, device 102 and/or device 140 may be configured to communicate according to a multi-link communication mechanism, which may implement one or more operations and/or functionalities for communication at an Enhanced Multilink Single-Radio (EMLSR) operation mode, e.g., in accordance with an IEEE 802.11 Specification and/or a Wi-Fi7 Specification, e.g., as described below.

In some demonstrative aspects, the EMLSR operation mode may be defined, e.g., in compliance with an IEEE 802.11be Specification, to include a mode of operation that allows a non-AP MLD with multiple receive chains to listen on a set of enabled links, for example, when the corresponding STAs affiliated with the non-AP MLD are in the awake state, for an initial control frame sent by an AP affiliated with an AP MLD. For example, the initial control frame may be sent by the AP in a non-high-throughput (non-HT) (duplicate) PPDU, for example, with one spatial stream. For example, the initial control frame may be followed by one or more frame exchanges on the link on which the initial Control frame was received. In other aspects, the EMLSR operation mode may be defined to include any other additional or alternative suitable functionality.

Some demonstrative aspects are described herein with respect to a wireless communication device, e.g., wireless communication device 102, operating according to an EMLSR operation mode. Other aspects may be implemented with respect to a wireless communication device, e.g., wireless communication device 102, operating according to any other additional or alternative multi-link operation mode.

In some demonstrative aspects, device 102 and/or device 140 may be configured to communicate according to an EMLSR operation mode, which may define that when a non-AP MLD, e.g., a non-AP MLD implemented by device 140, enters an EMLSR mode, the non-AP MLD may have at least two active links.

For example, the non-AP MLD operating at the EMLSR operation mode may be allowed to transmit only over one link at a time.

In some demonstrative aspects, a non-AP MLD, e.g., the non-AP MLD implemented by device 140, may have a first active link and a second active link, which may be configured differently from the first active link, for example, when operating at the EMLSR mode and/or during any other multi-link operation mode.

In some demonstrative aspects, the first active link and the second active link may have different PHY configurations, which may support different PHY rates, e.g., as described below.

In some demonstrative aspects, the first active link may be configured according to a first PHY configuration including a first bandwidth, a first nominal Modulation and Coding Scheme (MCS), a first Transmit (Tx) power limitation setting, and/or one or more first additional or alternative PHY settings.

For example, the first PHY configuration may support a first PHY rate for communication of data, e.g., in an Uplink (UL) transmission to an AP, e.g., an AP implemented by device 102. For example, the first PHY rate may support a first throughput for the UL transmission.

In some demonstrative aspects, the second active link may be configured according to a second PHY configuration including a second bandwidth, a second nominal MCS, a second Tx power limitation setting, and/or one or more second additional or alternative PHY settings.

For example, the second PHY configuration may support a second PHY rate, e.g., different from the first PHY rate, for communication of data, e.g., in an UL transmission to the AP, e.g., the AP implemented by device 102. For example, the second PHY rate may support a second throughput for the UL transmission, e.g., different from the first throughput.

In some demonstrative aspects, device 140 may be configured to implement one or more operations and/or functionalities of a multi-link communication mechanism, which may be configured to address one or more technical issues for communication over multiple links, for example, during the EMLSR operation mode and/or during any other multi-link operation mode, e.g., as described below.

In some demonstrative aspects, it may be advantageous to allow the non-AP MLD to select to use an active link having a higher throughput for the UL transmission to the AP, e.g., when the active link having the higher throughput is available.

In some demonstrative aspects, the non-AP MLD, e.g., the non-AP MLD implemented by device 140, may be configured to identify a particular active link, e.g., of the EMLSR mode, as a prioritized link (also referred to as “superior link” (S-link) or “primary link”), e.g., based on a determination that the particular active link supports a higher throughput.

In some demonstrative aspects, the non-AP MLD, e.g., the non-AP MLD implemented by device 140, may be configured to identify an other active link, e.g., of the EMLSR mode, as a de-prioritized link (also referred to as “inferior link” (I-link) or “secondary link”), for example, based on a determination that the other active link supports a lower throughput, e.g., compared to the superior link.

In some demonstrative aspects, the classification of the first link as the prioritized link, and/or the classification of the second link as the de-prioritized link may be determined according to a throughput criterion. In other aspects, the classification of the first link as the prioritized link, and/or the classification of the second link as the de-prioritized link may be determined according to any other additional or alternative classification criteria and/or parameters.

In some demonstrative aspects, for example, in some use cases and/or scenarios, a transmission initiated by the non-AP MLD on the inferior link may lead to degraded performance, e.g., degradation in average throughput.

In some demonstrative aspects, it may be advantageous to allow the non-AP MLD to select to use the superior link for the UL transmission to the AP, e.g., when the superior link is available.

For example, the non-AP MLD may select to defer transmission, e.g., by ignoring a transmit opportunity on the I-link.

For example, the non-AP MLD, e.g., when at the EMLSR operation mode, may be “deaf” on the link it is not currently transmitting on. Accordingly, a transmission on the inferior link may delay transmission opportunities on the superior link.

For example, in some use cases and/or scenarios, the superior link may become available, for example, after, e.g., shortly after, transmission on the inferior link starts. This may result in a missed opportunity to transmit over the superior link, e.g., at a better rate.

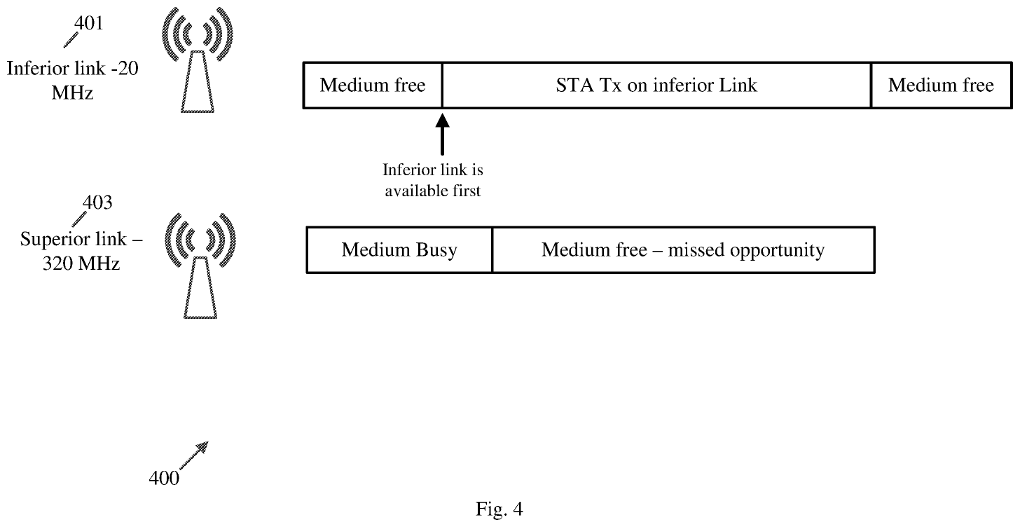

Reference is made to FIG. 4, which schematically illustrates a multi-link communication scenario 400 to illustrate technical issues, when may be addressed in accordance with some demonstrative aspects.

For example, as shown in FIG. 4, configuring a non-AP MLD operating at a multi-link mode, e.g., an EMLSR mode, to transmit on the first link that becomes available may lead to transmitter inefficiency, e.g., in case the non-AP MLD chooses to use the “wrong” link, e.g., the inferior link.

For example, as shown in FIG. 4, the non-AP MLD may select to use a link 401, e.g., a 20 MHz link, which may be the inferior link, for example, based on a determination that a link 403, e.g., a 320 MHz link, which may be the superior link, is busy.

For example, as shown in FIG. 4, as a result, the non-AP MLD may miss the opportunity to transmit on the 320 MHz link, which becomes available shortly after the beginning of the transmission on the 20 MHz link. This situation may lead to degraded performance, e.g., as the selected inferior link supports a throughput, which is 16 times slower than the superior link.

Referring back to FIG. 1, in some demonstrative aspects, device 140 may be configured to implement one or more operations and/or functionalities of a multi-link communication mechanism, which may be configured to control a selection of an active link to be used for an UL transmission to the AP, for example, during the EMLSR operation mode and/or any other suitable multi-link operation mode, e.g., as described below.

In some demonstrative aspects, device 140 may be configured to implement one or more operations and/or functionalities of a multi-link communication mechanism, which may be configured to prioritize transmissions over the superior link, for example, during the EMLSR operation mode and/or any other suitable multi-link operation mode, e.g., as described below.

In some demonstrative aspects, the multi-link communication mechanism may be configured to prioritize transmissions over the superior link, for example, even in case when the superior link is busy and the inferior link is free, e.g., as described below.

In some demonstrative aspects, device 140 may be configured to implement one or more operations and/or functionalities of a multi-link communication mechanism, which may be configured to limit transmissions over the inferior link, e.g., during the EMLSR operation mode and/or any other suitable multi-link operation mode, e.g., as described below.

In some demonstrative aspects, the multi-link communication mechanism may be configured to limit transmissions over the inferior link, for example, based on a determination that the superior link, which may be currently busy, is expected to be free, e.g., as described below.

In some demonstrative aspects, the multi-link communication mechanism may be configured to limit transmissions over the inferior link, for example, based on a determined duration during which the superior link is expected to be busy, e.g., as described below.

In some demonstrative aspects, controller 154 may be configured to control, trigger, cause, and/or instruct a non-AP MLD implemented by device 140 to assign a first priority to a first link of a multi-link operation mode and a second priority to a second link of the multi-link operation mode, e.g., as described below.

In some demonstrative aspects, the first priority may be higher than the second priority, e.g., as described below.

In some demonstrative aspects, controller 154 may be configured to control, trigger, cause, and/or instruct the non-AP MLD implemented by device 140 to limit a transmission from the non-AP MLD over the second link, for example, based on a busy state of a wireless communication medium of the first link, e.g., as described below.

In some demonstrative aspects, the multi-link operation mode may include an operation mode of a single-radio non-AP MLD at which, for example, the single-radio non-AP MLD is to receive or transmit frames only on one link at a time, e.g., as described below.

In some demonstrative aspects, the multi-link operation mode may include an EMLSR operation mode, e.g., as described below.

In other aspects, the multi-link operation mode may include any other additional or alternative type of multi-link operation mode.

In some demonstrative aspects, controller 154 may be configured to control, trigger, cause, and/or instruct the non-AP MLD implemented by device 140 to assign the first priority to the first link, for example, based on a first PHY configuration of the first link, e.g., as described below.

In some demonstrative aspects, controller 154 may be configured to control, trigger, cause, and/or instruct the non-AP MLD implemented by device 140 to assign the second priority to the second link, for example, based on a second PHY configuration of the second link, e.g., as described below.

In some demonstrative aspects, controller 154 may be configured to control, trigger, cause, and/or instruct the non-AP MLD implemented by device 140 to assign the first priority to the first link, for example, based on a first PHY rate corresponding to the first link, e.g., as described below.

In some demonstrative aspects, controller 154 may be configured to control, trigger, cause, and/or instruct the non-AP MLD implemented by device 140 to assign the second priority to the second link, for example, based on a second PHY rate corresponding to the second link, e.g., as described below.

In some demonstrative aspects, controller 154 may be configured to control, trigger, cause, and/or instruct the non-AP MLD implemented by device 140 to assign the first priority to the first link and the second priority to the second link, for example, based on a determination that the first PHY rate is higher than the second PHY rate, e.g., as described below.

In some demonstrative aspects, the first PHY rate may be based on a first channel BW of the first link, e.g., as described below.

In some demonstrative aspects, the first PHY rate may be based on a first throughput of the first link, e.g., as described below.

In some demonstrative aspects, the first PHY rate may be based on a first MCS of the first link, e.g., as described below.

In some demonstrative aspects, the first PHY rate may be based on a first Tx power setting of the first link, e.g., as described below.

In other aspects, the first PHY rate may be based on any other additional or alternative criteria and/or parameter corresponding to the first link.

In some demonstrative aspects, the second PHY rate may be based on a second channel BW of the second link, e.g., as described below.

In some demonstrative aspects, the second PHY rate may be based on a second throughput of the second link, e.g., as described below.

In some demonstrative aspects, the second PHY rate may be based on a second MCS of the second link, e.g., as described below.

In some demonstrative aspects, the second PHY rate may be based on a second Tx power setting of the second link, e.g., as described below.

In other aspects, the second PHY rate may be based on any other additional or alternative criteria and/or parameter corresponding to the second link.

In some demonstrative aspects, controller 154 may be configured to control, trigger, cause, and/or instruct the non-AP MLD implemented by device 140 to assign the first priority to the first link, for example, based on a first interference level of the first link, e.g., as described below.

In some demonstrative aspects, controller 154 may be configured to control, trigger, cause, and/or instruct the non-AP MLD implemented by device 140 to assign the second priority to the second link, for example, based on a second interference level of the second link, e.g., as described below.

In some demonstrative aspects, controller 154 may be configured to control, trigger, cause, and/or instruct the non-AP MLD implemented by device 140 to assign the first priority to the first link and the second priority to the second link, for example, based on a determination that the second interference level is higher than the first interference level, e.g., as described below.

In some demonstrative aspects, controller 154 may be configured to control, trigger, cause, and/or instruct the non-AP MLD implemented by device 140 to assign the first priority to the first link, for example, based on a first latency of the first link, e.g., as described below.

In some demonstrative aspects, controller 154 may be configured to control, trigger, cause, and/or instruct the non-AP MLD implemented by device 140 to assign the second priority to the second link, for example, based on a second latency of the second link, e.g., as described below.

In some demonstrative aspects, controller 154 may be configured to control, trigger, cause, and/or instruct the non-AP MLD implemented by device 140 to assign the first priority to the first link and the second priority to the second link, for example, based on a determination that the second latency is higher than the first latency, e.g., as described below.

In other aspects, controller 154 may be configured to control, trigger, cause, and/or instruct the non-AP MLD implemented by device 140 to assign the first priority to the first link and the second priority to the second link based on any other additional or alternative criteria relating to any other additional or alternative parameters and/or characteristics corresponding to the first link and/or the second link.

In some demonstrative aspects, the transmission from the non-AP MLD implemented by device 140 over the second link may include an UL transmission from the non-AP MLD to an AP MLD implemented by device 102.

In some demonstrative aspects, the transmission from the non-AP MLD implemented by device 140 over the second link may include a Peer-to-Peer transmission from the non-AP MLD to another non-AP MLD.

In other aspects, the transmission from the non-AP MLD implemented by device 140 over the second link may include any other suitable type of transmission.

In some demonstrative aspects, controller 154 may be configured to control, trigger, cause, and/or instruct the non-AP MLD implemented by device 140 to limit the transmission from the non-AP MLD over the second link, for example, based on a busy duration for the first link, e.g., as described below.

In some demonstrative aspects, the busy duration for the first link may include a duration during which the wireless communication medium of the first link is expected to be at the busy state, e.g., as described below.

In other aspects, the busy duration for the first link may be defined based on any other additional or alternative criteria.

In some demonstrative aspects, controller 154 may be configured to control, trigger, cause, and/or instruct the non-AP MLD implemented by device 140 to determine the busy duration for the first link, for example, based on information in a PPDU detected over the wireless communication medium of the first link, e.g., as described below.

In some demonstrative aspects, controller 154 may be configured to control, trigger, cause, and/or instruct the non-AP MLD implemented by device 140 to determine the busy duration for the first link, for example, based on information in a non-High-Throughput (non-HT) Signal (L-SIG) field of the PPDU detected over the wireless communication medium of the first link, e.g., as described below.

In some demonstrative aspects, controller 154 may be configured to control, trigger, cause, and/or instruct the non-AP MLD implemented by device 140 to determine the busy duration for the first link, for example, based on a duration value in a reservation frame to reserve the wireless communication medium of the first link, e.g., as described below.

In other aspects, controller 154 may be configured to control, trigger, cause, and/or instruct the non-AP MLD implemented by device 140 to determine the busy duration for the first link based on any other suitable additional or alternative information.

In some demonstrative aspects, controller 154 may be configured to control, trigger, cause, and/or instruct the non-AP MLD implemented by device 140 to limit the transmission from the non-AP MLD over the second link to the busy duration for the first link, e.g., as described below.

In some demonstrative aspects, controller 154 may be configured to control, trigger, cause, and/or instruct the non-AP MLD implemented by device 140 to select whether to allow or prohibit the transmission from the non-AP MLD over the second link, for example, based on a duration of the transmission from the non-AP MLD over the second link, and based on the busy duration for the first link, e.g., as described below.

In some demonstrative aspects, controller 154 may be configured to control, trigger, cause, and/or instruct the non-AP MLD implemented by device 140 to select whether to allow or prohibit the transmission from the non-AP MLD over the second link, for example, based on a comparison between the busy duration for the first link and the duration of the transmission from the non-AP MLD over the second link, e.g., as described below.

In other aspects, controller 154 may be configured to control, trigger, cause, and/or instruct the non-AP MLD implemented by device 140 to select whether to allow or prohibit the transmission from the non-AP MLD over the second link based on any other additional or alternative criteria.

In some demonstrative aspects, controller 154 may be configured to control, trigger, cause, and/or instruct the non-AP MLD implemented by device 140 to allow the transmission from the non-AP MLD over the second link, for example, based on a determination that the duration of the transmission from the non-AP MLD over the second link is not to exceed the busy duration for the first link, e.g., as described below.

In some demonstrative aspects, controller 154 may be configured to control, trigger, cause, and/or instruct the non-AP MLD implemented by device 140 to prohibit the transmission from the non-AP MLD over the second link, for example, based on a determination that the duration of the transmission from the non-AP MLD over the second link is to exceed the busy duration for the first link, e.g., as described below.

In some demonstrative aspects, controller 154 may be configured to control, trigger, cause, and/or instruct the non-AP MLD implemented by device 140 to refrain from transmitting the transmission from the non-AP MLD over the second link, for example, based on a determination that the duration of the transmission from the non-AP MLD over the second link is to exceed the busy duration for the first link, e.g., as described below.

In some demonstrative aspects, controller 154 may be configured to control, trigger, cause, and/or instruct the non-AP MLD implemented by device 140 to contend for the wireless communication medium of the first link to transmit the transmission from the non-AP MLD over the first link, for example, based on an end of the busy duration for the first link, e.g., as described below.

In some demonstrative aspects, controller 154 may be configured to control, trigger, cause, and/or instruct the non-AP MLD implemented by device 140 to determine the duration of the transmission from the non-AP MLD over the second link, for example, based on a duration of one or more reservation frames to reserve a wireless communication medium of the second link, e.g., as described below.

In some demonstrative aspects, controller 154 may be configured to control, trigger, cause, and/or instruct the non-AP MLD implemented by device 140 to determine the duration of the transmission from the non-AP MLD over the second link, for example, based on a duration of a PPDU to be transmitted from the non-AP MLD over the second link, e.g., as described below,

In some demonstrative aspects, controller 154 may be configured to control, trigger, cause, and/or instruct the non-AP MLD implemented by device 140 to determine the duration of the transmission from the non-AP MLD over the second link, for example, based on a duration of a response to the PPDU, e.g., as described below.

In some demonstrative aspects, controller 154 may be configured to control, trigger, cause, and/or instruct the non-AP MLD implemented by device 140 to determine the duration of the transmission from the non-AP MLD over the second link, for example, based on a sum of the duration of one or more reservation frames to reserve the wireless communication medium of the second link, the duration of a PPDU to be transmitted from the non-AP MLD over the second link, and the duration of the response to the PPDU, e.g., as described below.

In some demonstrative aspects, the response to the PPDU may include an acknowledgement (ACK) to acknowledge the PPDU, e.g., as described below.

In other aspects, the response to the PPDU may include any other suitable type of response.

In other aspects, the non-AP MLD may determine the duration of the transmission from the non-AP MLD over the second link based on a duration of any other additional or alternative frames.

In some demonstrative aspects, controller 154 may be configured to control, trigger, cause, and/or instruct the non-AP MLD implemented by device 140 to determine whether or not to allow the transmission from the non-AP MLD over the second link based on the busy duration for the first link, for example, based on a determination of an idle state of a wireless communication medium of the second link and the busy state of the wireless communication medium of the first link, e.g., as described below.

In some demonstrative aspects, device 140 may be configured to implement one or more operations and/or functionalities of a multi-link wireless communication mechanism, which may be configured to identify one or more links for a transmission from a non-AP MLD implemented by device 140 during a multi-link operation mode, e.g., as described below.

In some demonstrative aspects, device 140 may be configured to implement one or more operations and/or functionalities of the multi-link wireless communication mechanism, for example, to support prioritizing the one or more links during the multi-link operation mode, e.g., as described below.

In some demonstrative aspects, device 140 may be configured to identify a first link of a multi-link operation mode, e.g., an EMLSR operation mode, to be provided a first priority, and to identify a second link of the multi-link operation mode to be provided a second priority, e.g., as described below.

In some demonstrative aspects, device 140 may be configured to identify the first link of the multi-link operation mode, e.g. the EMLSR operation mode, as a primary (superior) link to be provided a first priority, e.g., a high priority.

In some demonstrative aspects, device 140 may be configured to identify the second link of the multi-link operation mode, e.g. the EMLSR operation mode, as the secondary (inferior) link to be provided a second priority, e.g., a low priority which is lower than the high priority, e.g., as described below.

In some demonstrative aspects, device 140 may be configured to identify the first link of the multi-link operation mode, e.g. the EMLSR operation mode, as the primary link, and/or to identify the second link of the multi-link operation mode, e.g. the EMLSR operation mode, as the secondary link, for example, based on PHY configurations, e.g., conceivable PHY rates, for transmission, e.g., UL transmission, over the first and second links, e.g., as described below.

In some demonstrative aspects, device 140 may be configured to limit an initiation of a transmission on the secondary link, e.g., over a secondary channel, for example, based on a busy state of the primary link, e.g., over a primary channel, e.g., as described below.

In some demonstrative aspects, device 140 may be configured to limit an initiation of a transmission on the secondary link (channel), for example, when the primary link (channel) is busy, e.g., as described below.

In some demonstrative aspects, device 140 may be configured to limit an initiation of a transmission on the secondary link (channel), for example, based on an expected time duration during which the primary link (channel) is expected to be busy, e.g., as described below.

In some demonstrative aspects, device 140 may be configured to selectively enable or disable the multi-link communication mechanism, for example, based on one or more predefined criteria.

In some demonstrative aspects, device 140 may be configured to selectively enable or disable the multi-link communication mechanism, for example, based on a size of data to be transmitted.

In some demonstrative aspects, device 140 may be configured to disable the multi-link communication mechanism, for example, based on a determination that the size of data to be transmitted is relatively small, e.g., less than a predefined data size threshold.

In some demonstrative aspects, device 140 may be configured to selectively enable or disable the multi-link communication mechanism, for example, based on a determination that the size of data to be transmitted is relatively small, and based on a selection to prioritize latency over throughput.

In some demonstrative aspects, device 140 may be configured to selectively enable or disable the multi-link communication mechanism, for example, based on a determination that there is no need to categorize the links as superior/inferior, for example, when both links support substantially the same throughput and/or any other parameter used for the classification of the links as superior/inferior.

In some demonstrative aspects, device 140 may be configured to disable the multi-link communication mechanism, for example, based on a determination that Downlink (DL) communications from the AP are not expected, e.g., within a predefined period.

In some demonstrative aspects, device 140 may be configured to prioritize and/or limit transmissions using a contention-based channel access mechanism, e.g., an Enhanced Distributed Channel Access (EDCA) procedure and/or any other contention mechanism, over the inferior-link, for example, to times when the superior-link is detected as busy.

In some demonstrative aspects, device 140 may be configured to determine that the superior link is busy, for example, based on Overlapping Basic Service Set (BSS) (OBSS) transmissions, and/or based on a determination that an over-the-air transmitted frame is destined to the AP or to another STA.

In some demonstrative aspects, device 140 may be configured to prioritize and/or limit transmissions using the contention-based channel access mechanism over the inferior-link, for example, based on a determination that the superior link is to remain busy for a sufficient amount of time, e.g., to complete an UL transmission over the inferior link.

In some demonstrative aspects, device 140 may be configured to prioritize and/or limit transmissions using the contention-based channel access mechanism over the inferior-link, for example, to the remaining air-busy time of the superior link.

In some demonstrative aspects, device 140 may be configured to prioritize and/or limit transmissions using the contention-based channel access mechanism over the inferior-link, for example, such that a transmission over the inferior link is to be limited to start and terminate, for example, when, e.g., only when, the superior link is not idle.

In some demonstrative aspects, device 140 may be configured to determine a receive sequence time of a transmission over the superior link, for example, based on information in a received PPDU over the superior link, e.g., as described below.

In some demonstrative aspects, device 140 may be configured to determine the receive sequence time of the transmission over the superior link, for example, based on information in a header of the received PPDU over the superior link.

In one example, the receive sequence time of the transmission over the superior link may be determined based on a PPDU duration. For example, the PPDU duration may be determined based on a Physical Layer Convergence Protocol (PLCP) L-SIG length field, and/or any other suitable header field.

In one example, the receive sequence time of the transmission over the superior link may be determined based on a Transmit Opportunity (TxOP) duration. For example, the TxOP duration may be determined based on a TXOP_DURATION field in a PPDU PHY header, e.g., in a High Efficiency (HE) SIG-A field, or a Universal Signal (U-SIG) field, and/or by a duration field in the MAC header.

In some demonstrative aspects, device 140 may be configured to determine the time for transmitting an Aggregate MPDU (A-MPDU) over the superior link, for example, based on a transmit sequence time including a TX Request-to-Send (RTS), a Receive (RX) Clear-to-Send (CTS), a TX A-MPDU or a Single MPDU (S-MPDU), and/or an RX Block Acknowledgement (BA) or ACK.

In some demonstrative aspects, a multi-link operation client, e.g., an EMLSR client, may be able to receive only some types of frames and/or some fields of frames during a listen state.

In one example, e.g., in accordance with an IEEE 802.11be Specification, a receiver of an EMLSR client may be able to correctly receive during a listening state only some types of frames and/or fields, for example, including an EMLSR Activation frame, e.g., an initial control frame; PPDUs having legacy rates, e.g., non-HT PPDUs, for example, RTS/CTS frames, control frames, or the like; and/or an L-SIG field of a PPDU.

For example, a receiver of a multi-link operation client, e.g., an EMLSR client, may be able to calculate the frame time of a non-legacy PPDU detected over the primary link, for example, based on information in one or more legacy fields of a received PPDU.

In one example, the receiver of the multi-link operation client, e.g., the EMLSR client, may be able to calculate the frame time of the non-legacy PPDU, for example, using a legacy length field in an L-SIG field of the PPDU over the primary link.

For example, the receiver of the multi-link operation client, e.g., the EMLSR client, may not be able to properly decode other portions of the PPDU detected over the primary link, and may accordingly determine an ‘invalid mac-header error’.

In some demonstrative aspects, the non-AP MLD may determine that the PPDU detected over the primary link may be treated as a “frame not for us”, for example, based on one or more detection criteria.

For example, the non-AP MLD may determine that the PPDU detected over the primary link may be treated as a “frame not for us” based on a determination that a MAC address of the detected PPDU does not match an address of the non-AP MLD.

For example, the non-AP MLD may determine that the PPDU detected over the primary link may be treated as a “frame not for us” based on a determination that a STA Identifier (STA-ID) in the PPDU does not match a STA ID of the non-AP MLD.

For example, the non-AP MLD may determine that the PPDU detected over the primary link may be treated as a “frame not for us” based on a determination that the PPDU is not from a BSSID of the non-AP MLD.

For example, the non-AP MLD may determine that the PPDU detected over the primary link may be treated as a “frame not for us” based on any other additional or alternative criteria.

For example, the non-AP MLD may determine that a transmission may be allowed over the secondary link, and that the transmission over the second link is to be limited, for example, by the duration of the detected PPDU over the primary link, e.g., as described below.

In some demonstrative aspects, device 140 may be configured to prioritize and/or limit transmissions using the contention-based channel access mechanism over the inferior-link, e.g., as described herein, for example, to provide a technical solution to support improved performance, e.g., improved transmit efficiency.

For example, in case an EMLSR client receives a frame over the superior-link, it may be assumed that the AP will (probably) not try to transmit to the EMLSR client, e.g., until the receive sequence is finished. For example, by this time the EMLSR client may be able to return to listen over the link.

For example, in case the EMLSR client transmits on one link, the AP may still try to send a frame to the EMLSR client on an other link, for example, due to AP implementation constraints (time race condition). This may lead to loss of efficiency. Accordingly, the time when another STA is receiving a frame from the AP over one link, may be used to transmit on the other link, for example, to reduce the chance of cross-link collision and, accordingly, to improve efficiency.

For example, the EMLSR client may be allowed to benefit from transmitting over the inferior-link, for example, during a calculated remaining time that the superior-link is to be busy. Accordingly, the EMLSR client should benefit from transmitting over the inferior link for this time. For example, the EMLSR client may reduce throughput to transmit over the inferior-link, e.g., in case the superior-link may become available.

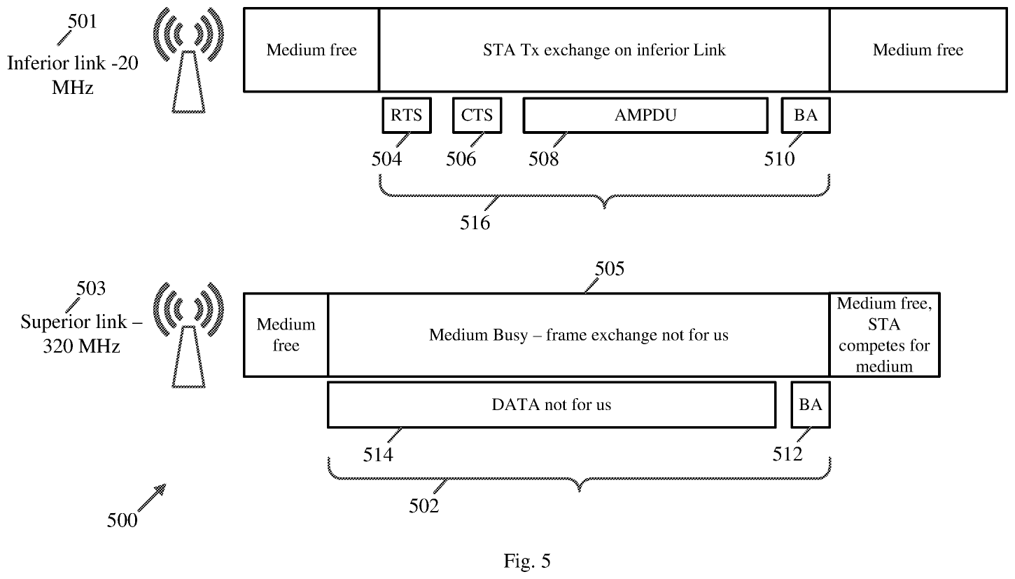

Reference is made to FIG. 5, which schematically illustrates a multi-link communication 500, in accordance with some demonstrative aspects. For example, controller 154 (FIG. 1) may be configured to control, trigger, and/or cause a non-AP MLD implemented by device 140 (FIG. 1) to perform one or more operations and/or functionalities according to FIG. 5.

In some demonstrative aspects, as shown in FIG. 5, a non-AP MLD, e.g., the non-AP MLD implemented by device 140 (FIG. 1), may have an active link 503 with an AP, e.g., a 320 MHz link, and an active link 501 with the AP, e.g., a 20 MHz link, at a multi-link operational mode, e.g., at an EMLSR operational mode.

In some demonstrative aspects, as shown in FIG. 5, the non-AP MLD, e.g., the non-AP MLD implemented by device 140 (FIG. 1), may identify active link 503 as a primary link (S-link), and may identify active link 501 as a secondary link (I-link), for example, based on the bandwidths of active link 503 and active link 501 and/or based on any other additional or alternative criteria.

In some demonstrative aspects, as shown in FIG. 5, the non-AP MLD, e.g., the non-AP MLD implemented by device 140 (FIG. 1), may identify an ongoing transmission 502 over active link 503 (“the primary link”), e.g., an Rx sequence for another STA (e.g., a frame detected as “frame not for us”).

In some demonstrative aspects, as shown in FIG. 5, the non-AP MLD, e.g., the non-AP MLD implemented by device 140 (FIG. 1), may identify a duration 505 of the ongoing transmission over active link 503 (the primary link), e.g., a duration covering and/or protecting a data transmission 514 to the other STA and a response, e.g., a BA 512 from the other STA.

In some demonstrative aspects, as shown in FIG. 5, the non-AP MLD, e.g., the non-AP MLD implemented by device 140 (FIG. 1), may allow the non-AP MLD to transmit over active link 501 (“the secondary link”), for example, during the duration 505 of the ongoing transmission over the primary link.

In some demonstrative aspects, as shown in FIG. 5, the non-AP MLD, e.g., the non-AP MLD implemented by device 140 (FIG. 1), may limit a transmission from the non-AP MLD over active link 501 (the secondary link), for example, to not exceed the duration 505 of the ongoing transmission over the primary link.

In some demonstrative aspects, as shown in FIG. 5, the non-AP MLD, e.g., the non-AP MLD implemented by device 140 (FIG. 1), may limit a Tx sequence 516, e.g., including an RTS transmission 504, a CTS transmission 506, a Data transmission 508, and a BA transmission 510, over active link 501 (the secondary link).

For example, as shown in FIG. 5, the non-AP MLD, e.g., the non-AP MLD implemented by device 140 (FIG. 1), may limit the Tx sequence 516 over active link 501 (the secondary link) to the remaining time of Rx sequence 502 over active link 503 (the primary link).

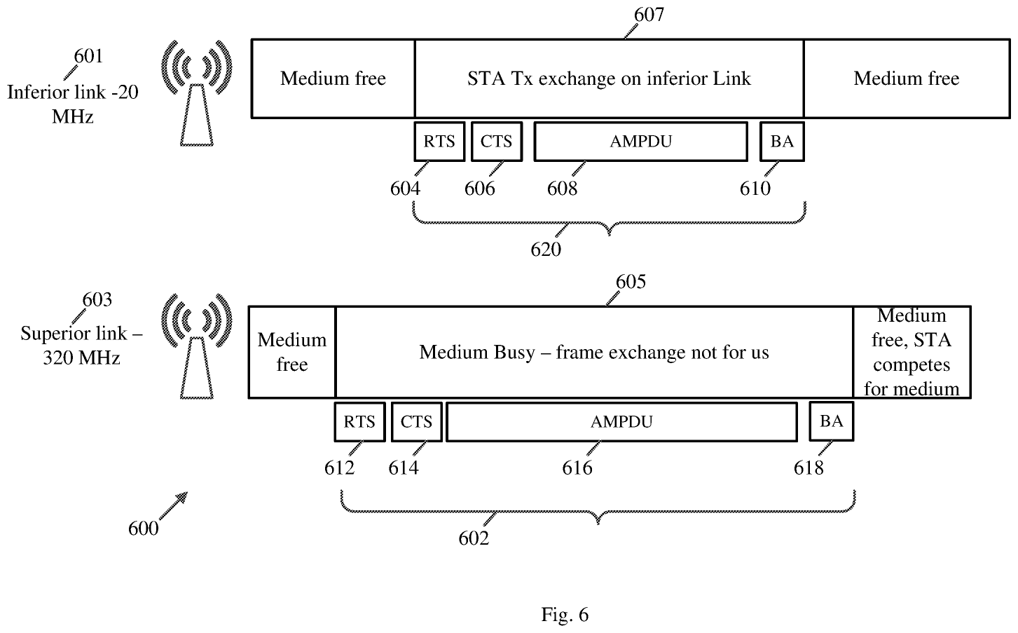

Reference is made to FIG. 6, which schematically illustrates a multi-link communication 600, in accordance with some demonstrative aspects. For example, controller 154 (FIG. 1) may be configured to control, trigger, and/or cause a non-AP MLD implemented by device 140 (FIG. 1) to perform one or more operations and/or functionalities according to FIG. 6.

In some demonstrative aspects, as shown in FIG. 6, a non-AP MLD, e.g., the non-AP MLD implemented by device 140 (FIG. 1), may have an active link 603 with an AP, e.g., a 320 MHz link, and an active link 601 with the AP, e.g., a 20 MHz link, at a multi-link operational mode, e.g., at an EMLSR operational mode.

In some demonstrative aspects, as shown in FIG. 6, the non-AP MLD, e.g., the non-AP MLD implemented by device 140 (FIG. 1), may identify the active link 603 as a primary link (S-link), and may identify the active link 601 as a secondary link (I-link), for example, based on the bandwidths of the active link 603 and active link 601 and/or based on any other additional or alternative criteria.

In some demonstrative aspects, as shown in FIG. 6, the non-AP MLD, e.g., the non-AP MLD implemented by device 140 (FIG. 1), may identify an ongoing transmission over the active link 603 (“the primary link”), e.g., an Rx sequence 602 for another STA.

In some demonstrative aspects, as shown in FIG. 6, the non-AP MLD, e.g., the non-AP MLD implemented by device 140 (FIG. 1), may identify a duration 605 of the ongoing transmission over the active link 603 (the primary link), e.g., a duration covering and/or protecting an RTS transmission 612, a CTS transmission 614, a Data transmission 616, and a BA transmission 618, of the Rx sequence 602 for the other STA.

In some demonstrative aspects, as shown in FIG. 6, the non-AP MLD, e.g., the non-AP MLD implemented by device 140 (FIG. 1), may allow the non-AP MLD to transmit over active link 601 (the secondary link), for example, during the duration 605 of the ongoing transmission over the primary link.

In some demonstrative aspects, as shown in FIG. 6, the non-AP MLD, e.g., the non-AP MLD implemented by device 140 (FIG. 1), may limit a transmission from the non-AP MLD over active link 601 (the secondary link), for example, to not exceed the duration 605 of the ongoing transmission over the primary link.

In some demonstrative aspects, as shown in FIG. 6, the non-AP MLD, e.g., the non-AP MLD implemented by device 140 (FIG. 1), may limit a Tx sequence 620, e.g., including an RTS transmission 604, a CTS transmission 606, a Data transmission 608, and a BA transmission 610, over active link 601 (the secondary link).

For example, as shown in FIG. 6, the non-AP MLD, e.g., the non-AP MLD implemented by device 140 (FIG. 1), may limit the Tx sequence 620 over active link 601 (the secondary link) to the remaining time of the Rx sequence 602 over active link 603 (the primary link).

Some demonstrative embodiments are described herein with respect to a multi-link communication mechanism configured to limit UL transmissions from a non-AP MLD to an AP over a secondary link, for example, based on a busy state of a primary link of the non-AP MLD, e.g., as described above.

In other aspects, the multi-link communication mechanism may be configured to limit any other type of transmissions from a non-AP MLD over the secondary link, e.g., P2P transmissions between the non-AP MLD and another non-AP MLD and/o any other transmissions, for example, based on a busy state of the primary link of the non-AP MLD.

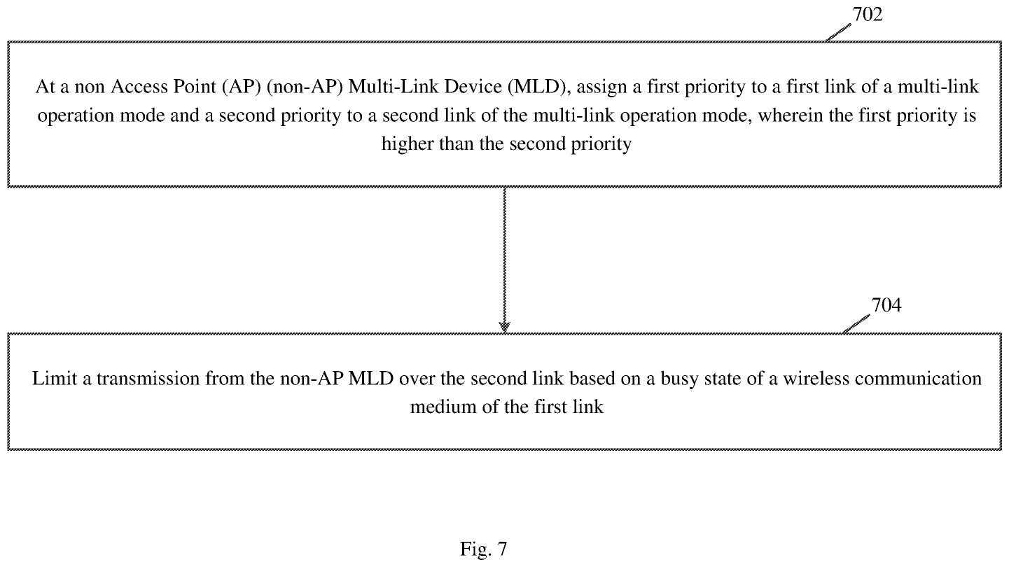

Reference is made to FIG. 7, which schematically illustrates a method of multi-link wireless communication, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include assigning, at a non-AP MLD, a first priority to a first link of a multi-link operation mode and a second priority to a second link of the multi-link operation mode. For example, the first priority may be higher than the second priority. For example, controller 154 (FIG. 1) may be configured to cause, trigger, and/or control device 140 (FIG. 1) to assign a first priority to a first link of a multi-link operation mode and a second priority to a second link of the multi-link operation mode, for example, such that the first priority is higher than the second priority, e.g., as described above.

As indicated at block 704, the method may include limiting a transmission from the non-AP MLD over the second link based on a busy state of a wireless communication medium of the first link. For example, controller 154 (FIG. 1) may be configured to cause, trigger, and/or control device 140 (FIG. 1) to limit a transmission from the non-AP MLD over the second link, for example, based on a busy state of a wireless communication medium of the first link, e.g., as described above.

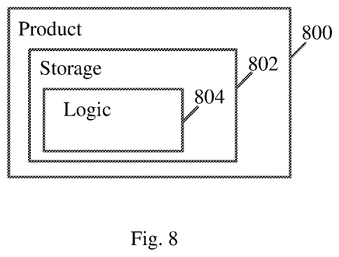

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a non Access Point (AP) (non-AP) Multi-Link Device (MLD) to assign a first priority to a first link of a multi-link operation mode and a second priority to a second link of the multi-link operation mode, wherein the first priority is higher than the second priority; and limit a transmission from the non-AP MLD over the second link based on a busy state of a wireless communication medium of the first link.

Example 2 includes the subject matter of Example 1, and optionally, wherein the apparatus is configured to cause the non-AP MLD to limit the transmission from the non-AP MLD over the second link based on a busy duration for the first link, the busy duration for the first link comprising a duration during which the wireless communication medium of the first link is expected to be at the busy state.

Example 3 includes the subject matter of Example 2, and optionally, wherein the apparatus is configured to cause the non-AP MLD to limit the transmission from the non-AP MLD over the second link to the busy duration for the first link.

Example 4 includes the subject matter of Example 2 or 3, and optionally, wherein the apparatus is configured to cause the non-AP MLD to select whether to allow or prohibit the transmission from the non-AP MLD over the second link based on a duration of the transmission from the non-AP MLD over the second link, and based on the busy duration for the first link.

Example 5 includes the subject matter of Example 4, and optionally, wherein the apparatus is configured to cause the non-AP MLD to select whether to allow or prohibit the transmission from the non-AP MLD over the second link based on a comparison between the busy duration for the first link and the duration of the transmission from the non-AP MLD over the second link.

Example 6 includes the subject matter of any one of Examples 2-5, and optionally, wherein the apparatus is configured to cause the non-AP MLD to allow the transmission from the non-AP MLD over the second link based on a determination that a duration of the transmission from the non-AP MLD over the second link is not to exceed the busy duration for the first link.

Example 7 includes the subject matter of any one of Examples 2-6, and optionally, wherein the apparatus is configured to cause the non-AP MLD to prohibit the transmission from the non-AP MLD over the second link based on a determination that a duration of the transmission from the non-AP MLD over the second link is to exceed the busy duration for the first link.

Example 8 includes the subject matter of any one of Examples 2-7, and optionally, wherein the apparatus is configured to cause the non-AP MLD to, based on a determination that a duration of the transmission from the non-AP MLD over the second link is to exceed the busy duration for the first link, refrain from transmitting the transmission from the non-AP MLD over the second link, and contend for the wireless communication medium of the first link to transmit the transmission from the non-AP MLD over the first link based on an end of the busy duration for the first link.

Example 9 includes the subject matter of any one of Examples 2-8, and optionally, wherein the apparatus is configured to cause the non-AP MLD to determine the duration of the transmission from the non-AP MLD over the second link based on a sum of a duration of one or more reservation frames to reserve a wireless communication medium of the second link, a duration of a Physical layer (PHY) Protocol Data Unit (PPDU) to be transmitted from the non-AP MLD over the second link, and a duration of a response to the PPDU.

Example 10 includes the subject matter of any one of Examples 2-9, and optionally, wherein the apparatus is configured to cause the non-AP MLD to, based on a determination of an idle state of a wireless communication medium of the second link and the busy state of the wireless communication medium of the first link, determine whether or not to allow the transmission from the non-AP MLD over the second link based on the busy duration for the first link.

Example 11 includes the subject matter of any one of Examples 2-10, and optionally, wherein the apparatus is configured to cause the non-AP MLD to determine the busy duration for the first link based on information in a Physical layer (PHY) Protocol Data Unit (PPDU) detected over the wireless communication medium of the first link.

Example 12 includes the subject matter of Example 11, and optionally, wherein the apparatus is configured to cause the non-AP MLD to determine the busy duration for the first link based on information in a non-High-Throughput (non-HT) Signal (L-SIG) field of the PPDU detected over the wireless communication medium of the first link.

Example 13 includes the subject matter of any one of Examples 2-12, and optionally, wherein the apparatus is configured to cause the non-AP MLD to determine the busy duration for the first link based on a duration value in a reservation frame to reserve the wireless communication medium of the first link.

Example 14 includes the subject matter of any one of Examples 1-13, and optionally, wherein the apparatus is configured to cause the non-AP MLD to assign the first priority to the first link and the second priority to the second link based on a first Physical layer (PHY) configuration of the first link and a second PHY configuration of the second link.

Example 15 includes the subject matter of any one of Examples 1-14, and optionally, wherein the apparatus is configured to cause the non-AP MLD to assign the first priority to the first link and the second priority to the second link based on a first Physical layer (PHY) rate corresponding to the first link and a second PHY rate corresponding to the second link.

Example 16 includes the subject matter of Example 15, and optionally, wherein the apparatus is configured to cause the non-AP MLD to assign the first priority to the first link and the second priority to the second link based on a determination that the first PHY rate is higher than the second PHY rate.

Example 17 includes the subject matter of Example 15 or 16, and optionally, wherein the first PHY rate is based on at least one of a first channel bandwidth (BW) of the first link, a first throughput of the first link, a first Modulation and Coding Scheme (MCS) of the first link, or a first Transmit (Tx) power setting of the first link, and wherein the second PHY rate is based on at least one of a second channel BW of the second link, a second throughput of the second link, a second MCS of the second link, or a second Tx power setting of the second link.

Example 18 includes the subject matter of any one of Examples 1-17, and optionally, wherein the apparatus is configured to cause the non-AP MLD to assign the first priority to the first link and the second priority to the second link based on a first interference level of the first link, and a second interference level of the second link.

Example 19 includes the subject matter of Example 18, and optionally, wherein the apparatus is configured to cause the non-AP MLD to assign the first priority to the first link and the second priority to the second link based on a determination that the second interference level is higher than the first interference level.

Example 20 includes the subject matter of any one of Examples 1-19, and optionally, wherein the apparatus is configured to cause the non-AP MLD to assign the first priority to the first link and the second priority to the second link based on a first latency of the first link, and a second latency of the second link.

Example 21 includes the subject matter of Example 20, and optionally, wherein the apparatus is configured to cause the non-AP MLD to assign the first priority to the first link and the second priority to the second link based on a determination that the second latency is higher than the first latency.

Example 22 includes the subject matter of any one of Examples 1-21, and optionally, wherein the transmission from the non-AP MLD over the second link comprises an uplink (UL) transmission from the non-AP MLD to an AP MLD.

Example 23 includes the subject matter of any one of Examples 1-21, and optionally, wherein the transmission from the non-AP MLD over the second link comprises a Peer-to-Peer transmission from the non-AP MLD to another non-AP MLD.

Example 24 includes the subject matter of any one of Examples 1-23, and optionally, wherein the multi-link operation mode comprises an operation mode of a single-radio non-AP MLD at which the single-radio non-AP MLD is to receive or transmit frames only on one link at a time.

Example 25 includes the subject matter of any one of Examples 1-24, and optionally, wherein the multi-link operation mode comprises an Enhanced Multi-Link Single Radio (EMLSR) operation mode.

Example 26 includes the subject matter of any one of Examples 1-25, and optionally, comprising a radio to transmit the transmission from the non-AP MLD over the second link.

Example 27 includes the subject matter of Example 26, and optionally, comprising one or more antennas connected to the radio, and a processor to execute instructions of an operating system of the non-AP MLD.

Example 28 comprises a wireless communication device comprising the apparatus of any of Examples 1-27.

Example 29 comprises a mobile device comprising the apparatus of any of Examples 1-27.

Example 30 comprises an apparatus comprising means for executing any of the described operations of any of Examples 1-27.

Example 31 comprises a product comprising one or more tangible computer-readable non-transitory storage media comprising instructions operable to, when executed by at least one processor, enable the at least one processor to cause a wireless communication device to perform any of the described operations of any of Examples 1-27.

Example 32 comprises an apparatus comprising: a memory interface; and processing circuitry configured to: perform any of the described operations of any of Examples 1-27.

Example 33 comprises a method comprising any of the described operations of any of Examples 1-27.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a non Access Point (AP) (non-AP) Multi-Link Device (MLD) to:
assign a first priority to a first link of a multi-link operation mode and a second priority to a second link of the multi-link operation mode, wherein the first priority is higher than the second priority; and
limit a transmission from the non-AP MLD over the second link based on a busy state of a wireless communication medium of the first link.

2. The apparatus of claim 1 configured to cause the non-AP MLD to limit the transmission from the non-AP MLD over the second link based on a busy duration for the first link, the busy duration for the first link comprising a duration during which the wireless communication medium of the first link is expected to be at the busy state.

3. The apparatus of claim 2 configured to cause the non-AP MLD to limit the transmission from the non-AP MLD over the second link to the busy duration for the first link.

4. The apparatus of claim 2 configured to cause the non-AP MLD to select whether to allow or prohibit the transmission from the non-AP MLD over the second link based on a duration of the transmission from the non-AP MLD over the second link, and based on the busy duration for the first link.

5. The apparatus of claim 2 configured to cause the non-AP MLD to allow the transmission from the non-AP MLD over the second link based on a determination that a duration of the transmission from the non-AP MLD over the second link is not to exceed the busy duration for the first link.

6. The apparatus of claim 2 configured to cause the non-AP MLD to prohibit the transmission from the non-AP MLD over the second link based on a determination that a duration of the transmission from the non-AP MLD over the second link is to exceed the busy duration for the first link.

7. The apparatus of claim 2 configured to cause the non-AP MLD to, based on a determination that a duration of the transmission from the non-AP MLD over the second link is to exceed the busy duration for the first link, refrain from transmitting the transmission from the non-AP MLD over the second link, and contend for the wireless communication medium of the first link to transmit the transmission from the non-AP MLD over the first link based on an end of the busy duration for the first link.

8. The apparatus of claim 2 configured to cause the non-AP MLD to determine the duration of the transmission from the non-AP MLD over the second link based on a sum of a duration of one or more reservation frames to reserve a wireless communication medium of the second link, a duration of a Physical layer (PHY) Protocol Data Unit (PPDU) to be transmitted from the non-AP MLD over the second link, and a duration of a response to the PPDU.

9. The apparatus of claim 2 configured to cause the non-AP MLD to, based on a determination of an idle state of a wireless communication medium of the second link and the busy state of the wireless communication medium of the first link, determine whether or not to allow the transmission from the non-AP MLD over the second link based on the busy duration for the first link.

10. The apparatus of claim 1 configured to cause the non-AP MLD to assign the first priority to the first link and the second priority to the second link based on a first Physical layer (PHY) configuration of the first link and a second PHY configuration of the second link.

11. The apparatus of claim 1 configured to cause the non-AP MLD to assign the first priority to the first link and the second priority to the second link based on a first Physical layer (PHY) rate corresponding to the first link and a second PHY rate corresponding to the second link.

12. The apparatus of claim 1 configured to cause the non-AP MLD to assign the first priority to the first link and the second priority to the second link based on a first interference level of the first link, and a second interference level of the second link.

13. The apparatus of claim 1 configured to cause the non-AP MLD to assign the first priority to the first link and the second priority to the second link based on a first latency of the first link, and a second latency of the second link.

14. The apparatus of claim 1, wherein the multi-link operation mode comprises an operation mode of a single-radio non-AP MLD at which the single-radio non-AP MLD is to receive or transmit frames only on one link at a time.

15. The apparatus of claim 1, wherein the multi-link operation mode comprises an Enhanced Multi-Link Single Radio (EMLSR) operation mode.

16. The apparatus of claim 1 comprising a radio to transmit the transmission from the non-AP MLD over the second link.

17. The apparatus of claim 16 comprising one or more antennas connected to the radio, and a processor to execute instructions of an operating system of the non-AP MLD.

18. A product comprising one or more tangible computer-readable non-transitory storage media comprising instructions operable to, when executed by at least one processor, enable the at least one processor to cause a non Access Point (AP) (non-AP) Multi-Link Device (MLD) to:
assign a first priority to a first link of a multi-link operation mode and a second priority to a second link of the multi-link operation mode, wherein the first priority is higher than the second priority; and
limit a transmission from the non-AP MLD over the second link based on a busy state of a wireless communication medium of the first link.

19. The product of claim 18, wherein the instructions, when executed, cause the non-AP MLD to limit the transmission from the non-AP MLD over the second link based on a busy duration for the first link, the busy duration for the first link comprising a duration during which the wireless communication medium of the first link is expected to be at the busy state.

20. The product of claim 19, wherein the instructions, when executed, cause the non-AP MLD to, based on a determination of an idle state of a wireless communication medium of the second link and the busy state of the wireless communication medium of the first link, determine whether or not to allow the transmission from the non-AP MLD over the second link based on the busy duration for the first link.
